(19) United States
(12) Patent Application Publication
(10) Pub. No.: US 2024/0118664 A1
(43) Pub. Date: Apr. 11, 2024

(54) Reversible Watch

(71) Applicant: Yi Yong CHUA, Singapore (SG)

(72) Inventor: Yi Yong CHUA, Singapore (SG)

(21) Appl. No.: 17/961,576

(22) Filed: Oct. 7, 2022

(51) Int. Cl. G04B 37/04; G04B 27/02; G04B 37/00

(52) U.S. Cl. CPC G04B 37/0472; G04B 27/026; G04B 37/0083

(57) ABSTRACT

The present disclosure provides a reversible watch with a secure and convenient flipping mechanism that facilitates quick and easy switching between two different watch faces. The mechanism comprises a timepiece block resting in and coupled to an outer frame by a pair of pivot joints about which it can rotate, and a set of ball bearings and corresponding indents that secure the timepiece to the frame when the time displays are aligned with the frame. The time displays are also separately controllable, allowing for users to conveniently switch between any two relative times.

### FIELD OF INVENTION

The present invention relates generally to timepieces. More specifically, the present invention relates to a reversible watch having a secure flipping mechanism and separately controllable time displays.

### BACKGROUND

A reversible watch is one whose case comprises two faces and a turning-over mechanism allowing the user to display, according to preference, one or the other face.

Various types of reversible watches are known in the art. For example, there are some that comprise two mechanical movements for displaying two time zones on the two faces of the watch, or for displaying the time on one face and auxiliary functions such as a chronograph, moon phase, date etc., on the other face.

Integrating two mechanical movements within a single case is however costly and requires a considerable thickness. Watches comprising a single mechanical movement capable of displaying indications on both opposite faces are also known; such movements however are not separately adjustable.

Furthermore, the mechanisms for swivelling between watch faces in prior art reversible watches leave much to be desired. They are often hard to operate, delicate, and have no way of securing the face in place when it is aligned with the frame.

It is within this context that the present invention is provided.

### SUMMARY

The present disclosure provides a reversible watch with a secure and convenient flipping mechanism that facilitates quick and easy switching between two different watch faces. The mechanism comprises a timepiece block resting in and coupled to an outer frame by a pair of pivot joints about which it can rotate, and a set of ball bearings and corresponding indents that secure the timepiece to the frame when the time displays are aligned with the frame. The time displays are also separately controllable, allowing for users to conveniently switch between any two relative times.

According to a first aspect of the present disclosure, there is provided a reversible watch, comprising: a timepiece block having a first rectangular clock face on a first side and a second rectangular clock face on an opposing second side, the first and second clock faces sharing a pair of lengthwise edges and a pair of widthwise edges, wherein the time display of the first clock face and the time display of the second clock face are separately controllable, and wherein each lengthwise edge has disposed thereon a pair of compressible ball bearings positioned either side of a central pivot joint.

The reversible watch further comprises a rectangular frame having a pair of widthwise walls and a pair of lengthwise walls, an inner surface of each of the pair of lengthwise walls being coupled to the corresponding central pivot joint of the timepiece block, thereby affixing the timepiece block in the frame while allowing rotation about the axis of the pivot joint, the inner surfaces of the lengthwise walls each further comprising a pair of indents for receiving a corresponding compressible ball bearing of the timepiece block to lock rotation of the timepiece block;

An outer surface of each of the widthwise walls of the frame is configured to couple to a watch strap.

In some embodiments, each of the clock faces utilises a separate quartz movement mechanism within the timepiece block for the time display. In other embodiments, each of the clock faces utilises a shared mechanical movement mechanism within the timepiece block for the time display.

In some embodiments, a single dial is positioned on a widthwise edge of the timepiece block for controlling the time displays of the first and second clock faces. Furthermore, the single dial may in some examples be moved between a first position along its rotational axis where it controls the first clock face and a second position along the rotational axis where it controls the second clock face.

In some embodiments, two separate dials are provided on opposing widthwise edges of the time piece block for controlling respective time displays of the first and second clock faces.

In some embodiments, one or more inner surfaces of the widthwise walls of the frame comprise an indent for accommodating control dials of the time piece block.

### BRIEF DESCRIPTION OF THE DRAWINGS

Various embodiments of the invention are disclosed in the following detailed description and accompanying drawings.

FIG. 1 illustrates a perspective view of an example configuration of a reversible watch according to the present disclosure, with a central timepiece block in alignment with an outer frame.

FIG. 2 illustrates a perspective view of the example configuration of the watch in a partially rotated position where the central block is out of alignment with the frame.

FIG. 3 illustrates a top-down view of the example configuration of the watch with the first time display facing outwards.

FIG. 4 illustrates a bottom up view of the example configuration of the watch with the second time display facing outwards.

FIG. 5 illustrates a perspective view of the frame of the example configuration of the watch with the central timepiece block removed to show the inner surfaces of the frame walls.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The illustrations of the present application show an example configuration of a timepiece for a reversible wristwatch according to the present disclosure without the straps of the wristwatch so as to better explain the mechanisms involved.

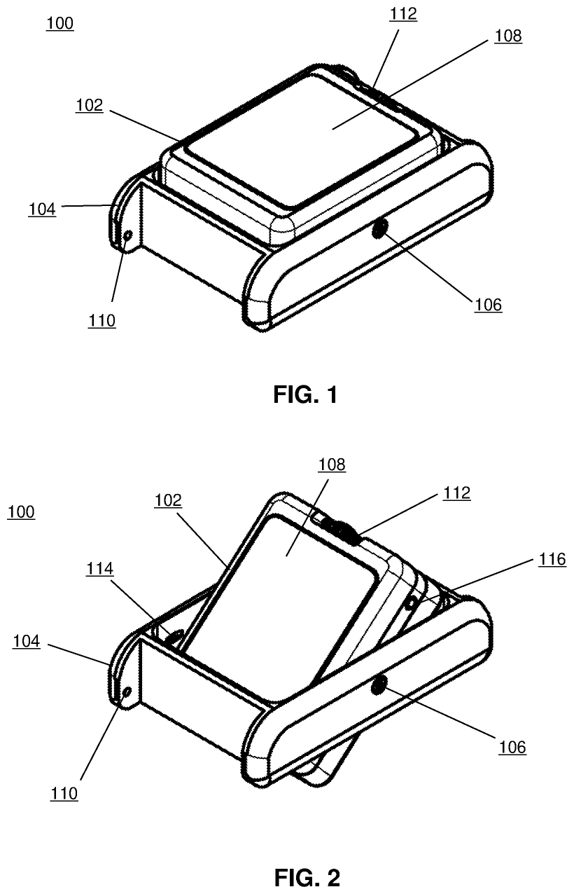

FIG. 1 and FIG. 2 show perspective views of the example configuration of the reversible watch 100, with FIG. 1 showing the central timepiece block 102 soft-locked in place in alignment with the outer frame 104 that holds it, and FIG. 2 showing the timepiece block 102 in the process of swivelling around with respect to the frame 104 to display a reverse face.

As can be seen, this rotation occurs about a pivot joint 106 that couples opposing edges of the timepiece block 102 to corresponding inner surfaces of the walls of the frame 104. The pivot joint 106 allows 360 rotation of the timepiece block 102 within the cavity formed by frame 104, and the axis of rotation is oriented transversely to the direction in which the wristwatch straps will be mounted at mounting points 110.

This arrangement allows a use to choose between a first time display on the front surface 108 of the timepiece block 102 and a second one on the opposing surface at the back, and to easily switch between the two. These two time displays are separately adjustable. In some examples this may be enabled by having two quartz movement mechanisms within the timepiece block 102, and in other examples by having a single mechanical arrangement that allows separate adjustment of each side. In the present example, a single control dial 112 is disposed at one end of the timepiece block, and the face of the watch that is controlled by it is determined by the longitudinal position of the dial, which can be moved up and down along its axis of rotation.

In FIG. 2, elements of the mechanism which keeps the timepiece block 102 soft locked in place when aligned with the frame 104 can be seen. Two opposing sides of the timepiece block 102 are each provided with a pair of compressible ball bearings 116 on either end. These ball bearings have rounded profiles and are able to be pushed inwards into the timepiece block using an elastic mechanism such as a spring.

When the timepiece block 102 rotates so that the ball bearings come into contact with the inner surface of the walls of the frame 104, the ball bearings are compressed inwards, then when the block 102 rotates to a point it is fully aligned with the frame 104 the ball bearings will align with corresponding indents 114 on the frame inner walls, and will have room to pop back out due to the force of the compressed spring mechanism.

This arrangement is symmetrical, and allows a soft lock to be achieved whenever the timepiece block 102 is fully aligned with the frame, which only occurs when either face of the reversible watch is facing outwards. This enables quick and secure changing between the watch faces for a user, with no unwanted angle adjustments occurring once the desired face is being displayed.

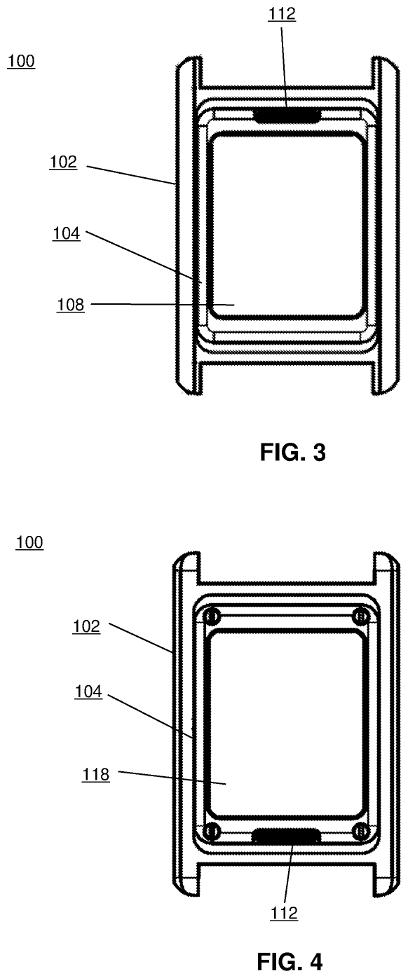

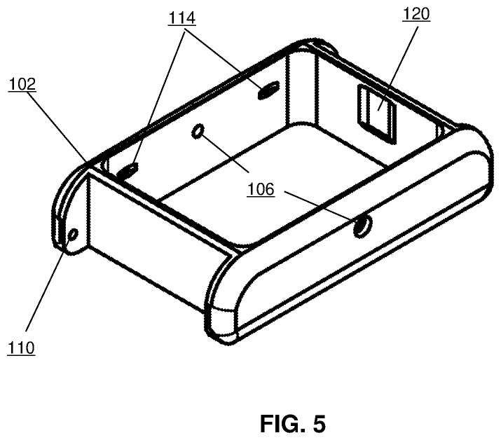

FIG. 3 and FIG. 4 show, respectively, a top-down view and a bottom-up view of the timepiece, with FIG. 4 showing the rear face 112 of the reversible watch.

FIG. 5 shows a perspective view of the frame 104 of the example configuration of the watch 100 with the central timepiece block removed to show the inner surfaces of the frame walls. Both the indentations 114 that correspond to the positions of the ball bearings can be seen on one wall.

Furthermore, as shown, the frame may also have one or more indents 120 for accommodating the protrusion of the control dial of the reversible watch.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the reversible watch have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A reversible watch, comprising:
a timepiece block having a first rectangular clock face on a first side and a second rectangular clock face on an opposing second side, the first and second clock faces sharing a pair of lengthwise edges and a pair of widthwise edges, wherein the time display of the first clock face and the time display of the second clock face are separately controllable, and wherein each lengthwise edge has disposed thereon a pair of compressible ball bearings positioned either side of a central pivot joint; and
a rectangular frame having a pair of widthwise walls and a pair of lengthwise walls, an inner surface of each of the pair of lengthwise walls being coupled to the corresponding central pivot joint of the timepiece block, thereby affixing the timepiece block in the frame while allowing rotation about the axis of the pivot joint, the inner surfaces of the lengthwise walls each further comprising a pair of indents for receiving a corresponding compressible ball bearing of the timepiece block to lock rotation of the timepiece block;
wherein an outer surface of each of the widthwise walls of the frame is configured to couple to a watch strap.

2. A reversible watch according to claim 1, wherein each of the clock faces utilises a separate quartz movement mechanism within the timepiece block for the time display.

3. A reversible watch according to claim 1, each of the clock faces utilises a shared mechanical movement mechanism within the timepiece block for the time display.

4. A reversible watch according to claim 1, wherein a single dial is positioned on a widthwise edge of the timepiece block for controlling the time displays of the first and second clock faces.

5. A reversible watch according to claim 4, wherein the single dial can be moved between a first position along its rotational axis where it controls the first clock face and a second position along the rotational axis where it controls the second clock face.

6. A reversible watch according to claim 1, wherein two separate dials are provided on opposing widthwise edges of the time piece block for controlling respective time displays of the first and second clock faces.

7. A reversible watch according to claim 1, wherein one or more inner surfaces of the widthwise walls of the frame comprise an indent for accommodating control dials of the time piece block.
